(19) United States
(12) Patent Application Publication
(10) Pub. No.: US 2006/0094810 A1
(43) Pub. Date: May 4, 2006

(54) Multi-layer container having barrier property

(76) Inventors: Myung Ho Kim, Daejeon-city (KR); Youngtock Oh, Daejeon-city (KR); Youngchul Yang, Daejeon-city (KR); Minki Kim, Daejeon-city (KR); Jaeyong Shin, Daejeon-city (KR); Sehyun Kim, Daejeon-city (KR)

Correspondence Address: CANTOR COLBURN, LLP, 55 GRIFFIN ROAD SOUTH, BLOOMFIELD, CT, 06002, US

(21) Appl. No.: 11/249,863

(22) Filed: Oct. 13, 2005

(30) Foreign Application Priority Data
Nov. 1, 2004 (KR) 10-2004-0087925
Jun. 2, 2005 (KR) 10-2005-0047121

(51) Int. Cl. C08K 3/34

(52) U.S. Cl. 524/445

(57) ABSTRACT

A multi-layer container having a barrier property comprising a polyolefin layer and a nanocomposite blend layer is provided. The multi-layer container maintains a sufficient adhesive strength when contacting gasoline or gasohol, has good durability over a long period of time, and has superior barrier properties to gasoline and organic solvents, and thus is suitable for use in a fuel tank for vehicles.

### CROSS-REFERENCE TO RELATED PATENT APPLICATION

This application claims the benefit of Korean Patent Application No. 10-2004-0087925, filed on Nov. 1, 2004, and Korean Patent Application No. 10-2005-0047121, filed on Jun. 2, 2005, in the Korean Intellectual Property Office, the disclosures of which are incorporated herein in their entirety by reference.

### BACKGROUND OF THE INVENTION

1. Field of the Invention

The present invention relates to a multi-layer container having a barrier property including a polyolefin layer and a nanocomposite blend layer.

2. Description of the Related Art

Fuel tanks for vehicles and containers for agrochemicals, cosmetics, foods, etc. are generally manufactured using a blow molding process. When using a blow molding process, it is important to endow these containers with a predetermined strength and to improve their barrier property to prevent the leakage of contents as well.

For a fuel tank for vehicles, a tank made of high density polyethylene (HDPE) and having an inner wall coated with fluorine, a blow-molded article of a blend of HDPE and SELAR (manufactured by Dupont, USA), a multi-layer structure including inner and outer layers composed of HDPE and a fuel resistant layer composed of ethylene-vinyl alcohol (EVOH) and a regrind layer composed of recycled materials between the inner and outer layers, etc. are used to improve a barrier property to fuel. When the fluorine-coated HDPE fuel tank is used for a long period of time, the fluorine coating is worn, resulting in reduction in fuel resistance and impact strength of the fuel tank. When HDPE and SELAR are blended, recycling possibility is reduced and a barrier property to fuel including alcohol is insufficient.

The multi-layer structure generally includes HDPE/regrind layer/adhesive layer/EVOH/adhesive layer/HDPE and exhibits a better barrier property than when HDPE and SELAR are blended or the fluorine-coated HDPE fuel tank. However, the multi-layer structure does not satisfy the recently rigidified regulation for vaporized gas of vehicles, i.e., PZEV (Partial Zero-Emission Vehicle) regulation, and thus tends to be substituted by steel. Further, in the multi-layer structure, gasoline present inside the inner wall permeates the HDPE layer and the regrind layer, and thus the adhesive layer interposed between the EVOH and the regrind layer are immersed in and swollen by gasoline, resulting in a reduction in adhesive strength at high temperatures.

### SUMMARY OF THE INVENTION

The present invention provides a multi-layer container which has a sufficient barrier property to satisfy the PZEV regulation, can maintain sufficient adhesive strength even when contacting gasoline or gasohol, has good durability over a long period of time, and has a high adhesive strength even at high temperatures, and thus is suitable for use in a fuel tank for vehicles and a container for agrochemicals and chemicals.

According to an aspect of the present invention, there is provided a multi-layer container having a barrier property including a nanocomposite blend layer and at least one layer selected from the group consisting of a polyolefin layer, a layer of a resin having a barrier property and a regrind layer, in which the nanocomposite blend layer is prepared from a dry-blended composition including: 40 to 98 parts by weight of a polyolefin resin; 0.5 to 60 parts by weight of a nanocomposite having a barrier property, selected from the group consisting of an ethylene-vinyl alcohol (EVOH) copolymer/intercalated clay nanocomposite, a polyamide/intercalated clay nanocomposite, an ionomer/intercalated clay nanocomposite, and a polyvinyl alcohol (PVA)/intercalated clay nanocomposite; and 1 to 30 parts by weight of a compatibilizer.

In an embodiment of the present invention, the polyolefin resin may be at least one compound selected from the group consisting of a high density polyethylene (HDPE), a low density polyethylene (LDPE), a linear low density polyethylene (LLDPE), an ethylene-propylene copolymer, metallocene polyethylene, and polypropylene.

In another embodiment of the present invention, the intercalated clay may be at least one material selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

In another embodiment of the present invention, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

In another embodiment of the present invention, the ionomer may have a melt index of 0.1 to 10 g/10 min (190° C., 2,160 g).

In another embodiment of the present invention, the compatibilizer may be at least one compound selected from an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, a maleic anhydride modified (graft) ethylene-vinyl acetate copolymer.

In another embodiment of the present invention, the resin having a barrier property may be at least one compound selected from the group consisting of an EVOH copolymer, a polyamide, an ionomer and a PVA.

In another embodiment of the present invention, the multi-layer container having a barrier property may further include an adhesive layer.

### DETAILED DESCRIPTION OF THE INVENTION

The present invention will now be explained in more detail.

A multi-layer container having a barrier property according to an embodiment of the present invention includes: a nanocomposite blend layer; and at least one layer selected from the group consisting of a polyolefin layer, a layer of a resin having a barrier property and a regrind layer, in which the nanocomposite blend layer is prepared from a dry-blended composition including: 40 to 98 parts by weight of a polyolefin resin; 0.5 to 60 parts by weight of a nanocomposite having a barrier property, selected from the group consisting of an ethylene-vinyl alcohol (EVOH) copolymer/intercalated clay nanocomposite, a polyamide/intercalated clay nanocomposite, an ionomer/intercalated clay nanocomposite, and a polyvinyl alcohol (PVA)/intercalated clay nanocomposite; and 1 to 30 parts by weight of a compatibilizer.

The weight ratio of the resin having a barrier property to the intercalated clay in the nanocomposite is 58.0:42.0 to 99.9:0.1, and preferably 85.0:15.0 to 99.0:1.0. If the weight ratio of the resin having a barrier property to the intercalated clay is less than 58.0:42.0, the intercalated clay agglomerates and dispersing is difficult. If the weight ratio of the resin having a barrier property to the intercalated clay is greater than 99.9:0.1, the improvement in the barrier property is negligible.

The polyolefin resin may include at least one compound selected from the group consisting of a high density polyethylene (HDPE), a low density polyethylene (LDPE), a linear low density polyethylene (LLDPE), an ethylene-propylene copolymer, metallocene polyethylene, and polypropylene. The polypropylene may be at least one compound selected from the group consisting of a homopolymer of propylene, a copolymer of propylene, metallocene polypropylene and a composite resin having improved physical properties by adding talc, flame retardant, etc. to a homopolymer or copolymer of propylene.

The content of the polyolefin resin is preferably 40 to 98 parts by weight, and more preferably 70 to 96 parts by weight. If the content of the polyolefin resin is less than 40 parts by weight, molding is difficult. If the content of the polyolefin resin is greater than 98 parts by weight, the barrier property is poor.

The nanocomposite having a barrier property may be prepared by blending an intercalated clay with at least one resin selected from the group consisting of an ethylene-vinyl alcohol copolymer, a polyamide, an ionomer and a polyvinyl alcohol.

The intercalated clay is preferably organic intercalated clay. The content of an organic material in the intercalated clay is preferably 1 to 45 wt %. When the content of the organic material is less than 1 wt %, the compatibility of the intercalated clay and the resin having a barrier property is poor. When the content of the organic material is greater than 45 wt %, the intercalation of the resin having a barrier property is difficult. The organic material has at least one functional group selected from the group consisting of primary ammonium to quaternary ammonium, phosphonium, maleate, succinate, acrylate, benzylic hydrogen, dimethyldistearylammonium, and oxazoline.

The intercalated clay includes at least one material selected from montmorillonite, bentonite, kaolinite, mica, hectorite, fluorohectorite, saponite, beidelite, nontronite, stevensite, vermiculite, hallosite, volkonskoite, suconite, magadite, and kenyalite; and the organic material preferably has a functional group selected from primary ammonium to quaternary ammonium, phosphonium, maleate, succinate, acrylate, benzylic hydrogen, dimethyldistearylammonium, and oxazoline.

If an ethylene-vinyl alcohol copolymer is included in the nanocomposite, the content of ethylene in the ethylene-vinyl alcohol copolymer is preferably 10 to 50 mol %. If the ethylene content is less than 10 mol %, melt molding becomes difficult due to poor processability. If the ethylene content exceeds 50 mol %, oxygen and liquid barrier properties are insufficient.

If polyamide is included in the nanocomposite, the polyamide may be nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

If an ionomer is included in the nanocomposite, the ionomer is preferably a copolymer of acrylic acid and ethylene, with a melt index of 0.1 to 10 g/10 min (190° C., 2,160 g).

The content of the nanocomposite is preferably 0.5 to 60 parts by weight, and more preferably 3 to 30 parts by weight. If the content of the nanocomposite is less than 0.5 part by weight, an improvement of a barrier property is negligible. If the content of the nanocomposite is greater than 60 parts by weight, processing is difficult.

The finer the intercalated clay is exfoliated in the resin having a barrier property in the nanocomposite, the better the barrier property that can be obtained. This is because the exfoliated intercalated clay forms a barrier film and thereby improves the barrier property and mechanical properties of the resin itself, and ultimately improves the barrier property and mechanical properties of a molded article prepared from the composition. Accordingly, the ability to form a barrier to gas and liquid is maximized by compounding the resin having a barrier property and the intercalated clay, and dispersing the nano-sized intercalated clay in the resin, thereby maximizing the contact area of the polymer chain and the intercalated clay.

The compatibilizer improves the compatibility of the polyolefin resin in the nanocomposite to form a molded article with a stable structure.

The compatibilizer may be a hydrocarbon polymer having polar groups. When a hydrocarbon polymer having polar groups is used, the hydrocarbon polymer portion increases the affinity of the compatibilizer to the polyolefin resin and to the nanocomposite having a barrier property, thereby obtaining a molded article with a stable structure.

The hydrocarbon polymer can include at least one compound selected from an epoxy-modified polystyrene copolymer, an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, a maleic anhydride modified (graft) ethylene-vinyl acetate copolymer, and a modification thereof.

The content of the compatibilizer is preferably 1 to 30 parts by weight, and more preferably 2 to 15 parts by weight. If the content of the compatibilizer is less than 1 part by weight, the mechanical properties of a molded article from the composition are poor. If the content of the compatibilizer is greater than 30 parts by weight, the molding of the composition is difficult.

When an epoxy-modified polystyrene copolymer is used as the compatibilizer, a copolymer comprising a main chain which comprises 70 to 99 parts by weight of styrene and 1 to 30 part by weight of an epoxy compound represented by Formula (1), and branches which comprise 1 to 80 parts by weight of acrylic monomers represented by Formula (2), is preferable.

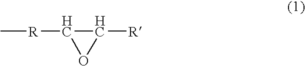

where each of R and R′ is independently a C₁-C₂₀ aliphatic residue or a C₅-C₂₀ aromatic residue having double bonds at its termini

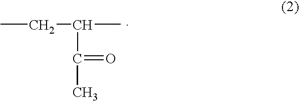

Each of the maleic anhydride modified (graft) high-density polyethylene, maleic anhydride modified (graft) linear low-density polyethylene, and maleic anhydride modified (graft) ethylene-vinyl acetate copolymer preferably comprises branches having 0.1 to 10 parts by weight of maleic anhydride based on 100 parts by weight of the main chain. When the content of the maleic anhydride is less than 0.1 part by weight, it does not function as the compatibilizer. When the content of the maleic anhydride is greater than 10 parts by weight, it is not preferable due to an unpleasant odor.

The composition of the present invention is prepared by dry-blending the nanocomposite having a barrier property in a pellet form, the compatibilizer and the polyolefin resin at a constant compositional ratio in a pellet mixer. The dry-blended nanocomposite composition is extruded to form a nanocomposite blend layer.

The layer of a resin having a barrier property may be composed of at least one compound selected from the group consisting of an ethylene-vinyl alcohol copolymer, a polyamide, an ionomer, and a polyvinyl alcohol.

The regrind layer is composed of a composition obtained by pulverizing unused portions of components of other layers in the multi-layer container and, if necessary, compounding the pulverized components in an extruder, etc., and can exist unless departing from the purpose of the multi-layer container. The regrind layer is required to be composed of only the recovered unused portions and, for example, can be compounded with a polyethylene resin to improve a mechanical property.

The multi-layer container of the present embodiment may further include an adhesive layer. The adhesive layer can be composed of the same component as the compatibilizer and improves an adhesive strength between layers. For example, the adhesive layer may be composed of a hydrocarbon polymer having polar groups. The hydrocarbon polymer can include at least one compound selected from an epoxy-modified polystyrene copolymer, an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, a maleic anhydride modified (graft) ethylene-vinyl acetate copolymer, and a modification thereof.

Each of layers constituting the multi-layer container may include known additives such as a filler, a stabilizer, a lubricant, an antistatic agent, a flame retardant, a blowing agent, etc. unless departing from the purpose of the present invention.

The nanocomposite blend layer may be prepared by molding a dry-blended composition including: 70 to 96 parts by weight of a polyolefin resin; 3 to 30 parts by weight of a nanocomposite having a barrier property, selected from the group consisting of an ethylene-vinyl alcohol (EVOH) copolymer/intercalated clay nanocomposite, a polyamide/intercalated clay nanocomposite, an ionomer/intercalated clay nanocomposite, and a polyvinyl alcohol (PVA)/intercalated clay nanocomposite; and 2 to 15 parts by weight of a compatibilizer.

The multi-layer container according to the present embodiment has a layered structure selected from the group consisting of polyolefin layer/nanocomposite blend layer, polyolefin layer/nanocomposite blend layer/polyolefin layer, nanocomposite blend layer/polyolefin layer/nanocomposite blend layer, polyolefin layer/nanocomposite blend layer/regrind layer, nanocomposite blend layer/resin layer having a barrier property/nanocomposite blend layer, nanocomposite blend layer/polyolefin layer/nanocomposite blend layer/polyolefin layer, nanocomposite blend layer/regrind layer/polyolefin layer/nanocomposite blend layer, polyolefin layer/nanocomposite blend layer/polyolefin layer/nanocomposite blend layer/polyolefin layer, regrind layer/nanocomposite blend layer/polyolefin layer/nanocomposite blend layer/polyolefin layer, nanocomposite blend layer/regrind layer/nanocomposite blend layer/polyolefin layer/nanocomposite blend layer, nanocomposite blend layer/regrind layer/nanocomposite blend layer/polyolefin layer/nanocomposite blend layer/polyolefin layer, nanocomposite blend layer/polyolefin layer/nanocomposite blend layer/polyolefin layer/nanocomposite blend layer/polyolefin layer, polyolefin layer/regrind layer/nanocomposite blend layer/polyolefin layer/nanocomposite blend layer/polyolefin layer, and polyolefin layer/nanocomposite blend layer/regrind layer/nanocomposite blend layer/polyolefin layer/nanocomposite blend layer.

When the multi-layer container further includes an adhesive layer, it may have a layered structure selected from the group consisting of regrind layer/polyolefin layer/adhesive layer/nanocomposite blend layer, resin layer having a barrier property/adhesive layer/regrind layer/nanocomposite blend layer, resin layer having a barrier property/adhesive layer/nanocomposite blend layer/polyolefin layer, resin layer having a barrier property/adhesive layer/nanocomposite blend layer/regrind layer, nanocomposite blend layer/adhesive layer/resin layer having a barrier property/adhesive layer/nanocomposite blend layer, nanocomposite blend layer/adhesive layer/resin layer having a barrier property/adhesive layer/polyolefin layer, polyolefin layer/adhesive layer/resin layer having a barrier property/adhesive layer/nanocomposite blend layer, nanocomposite blend layer/regrind layer/adhesive layer/resin layer having a barrier property/adhesive layer/nanocomposite blend layer, nanocomposite blend layer/polyolefin layer/adhesive layer/resin layer having a barrier property/adhesive layer/polyolefin layer, polyolefin layer/regrind layer/adhesive layer/nanocomposite blend layer/adhesive layer/polyolefin layer, and polyolefin layer/nanocomposite blend layer/adhesive layer/resin layer having a barrier property/adhesive layer/polyolefin layer.

The multi-layer container may be manufactured using a known co-extrusion blow molding method by melting and co-extruding resins using a plurality of extruders to form a molten parison, injecting a pressurized fluid into the parison in a mold to form a predetermined shape, cooling and solidifying the molded article, and removing the molded article from the mold.

The multi-layer container has a superior barrier property to gasoline and a high impact strength, superior adhesive strength between layers, durability and thermal resistance, and thus can be effectively used as a fuel tank for vehicles.

Hereinafter, the present invention is described in more detail through examples. The following examples are meant only to increase understanding of the present invention, and are not meant to limit the scope of the invention.

### EXAMPLES

The materials used in the following examples are as follows:

EVOH: E105B (Kuraray, Japan)

Nylon 6: EN 300 (KP Chemicals)

HDPE-g-MAH: Compatibilizer, PB3009 (CRAMPTON)

HDPE: Basell lupolene 4261AG

Clay: Closite 20A (SCP)

Thermal stabilizer: IR 1098 (Songwon Inc.)

Adhesive resin: AB130 (LG CHEM)

### Preparation Example 1

(Preparation of EVOH/Intercalated Clay Nanocomposite)

97 wt % of an ethylene-vinyl alcohol copolymer (EVOH; E-105B (ethylene content: 44 mol %); Kuraray, Japan; melt index: 5.5 g/10 min; density: 1.14 g/cm³) was put in the main hopper of a twin screw extruder (SM Platek co-rotation twin screw extruder; φ40). Then, 3 wt % of organic montmorillonite (Southern Intercalated Clay Products, USA; Closite 20A) as an intercalated clay and 0.1 part by weight of IR 1098 as a thermal stabilizer based on total 100 parts by weight of the EVOH copolymer and the organic montmorillonite were separately put in the side feeder of the twin screw extruder to prepare an EVOH/intercalated clay nanocomposite in a pellet form. The extrusion temperature condition was 180-190-200-200-200-200-200° C., the screws were rotated at 300 rpm, and the discharge condition was 30 kg/hr.

### Preparation Example 2

(Preparation of Nylon 6/Intercalated Clay Nanocomposite)

97 wt % of a polyamide (nylon 6, EN300) was put in the main hopper of a twin screw extruder (SM Platek co-rotation twin screw extruder; φ40). Then, 3 wt % of organic montmorillonite as an intercalated clay and 0.1 part by weight of IR 1098 as a thermal stabilizer based on total 100 parts by weight of the polyamide and the organic montmorillonite were separately put in the side feeder of the twin screw extruder to prepare a polyamide/intercalated clay nanocomposite in a pellet form. The extrusion temperature condition was 220-225-245-245-245-245-245° C., the screws were rotated at 300 rpm, and the discharge condition was 40 kg/hr.

### Example 1

Layer (A): 30 parts by weight of the EVOH/intercalated clay nanocomposite prepared in the Preparation Example 1, 4 parts by weight of a compatibilizer, and 66 parts by weight of HDPE were dry-blended to prepare a dry blend in a pellet form to be used as a nanocomposite blend layer (A).

Layer (C): AB130 pellet (LG CHEM) in which a PE main chain was grafted with maleic anhydride (MAH) to introduce a polar group was used.

Layer (D): EVOH (E105B; Kuraray) pellet was used.

Layer (E): Lupolene 4261 (HMWPE; Basell) pellet was used.

Layer (B): Burrs of a blow molded article comprising Layers (A), (C), (D) and (E) were pulverized and extruded to prepare a pellet for Layer (B).

The obtained pellets were extruded in order of (A)/(B)/(C)/(D)/(C)/(A) using a co-extrusion die (die temperature: 230° C.) to prepare a parison in a molten state. The parison was disposed in a mold and was blown with pressurized air with a pressure of 5 kg/cm². The resulting molded article was cooled, and then was removed from the mold. As a result, a bottle with layer thicknesses of 0.5/0.3/0.2/0.2/0.2/0.5 mm, a diameter of 80 mm, a height of 200 mm and a volume of 500 mL was obtained. The bottle was charged with 500 g of Ref.C (a mixture of 50% toluene and 50% isooctane) and was let alone in a thermostatic chamber at 60° C. for 60 days. After 30 days, a change in weight of the content was measured and the results are shown in Table 1. The content was removed from the bottle immediately after the measurement. After 5 minutes, a specimen with a width of 15 mm was cut from a side of the bottle and the adhesive strength between Layers (B) and (C) was measured in a thermostatic chamber at 80° C. using T-peeling method at a peeling rate of 50 mm/min. The results are shown in Table 2.

### Example 2

Layer (A): 30 parts by weight of the nylon 6/intercalated clay nanocomposite prepared in the Preparation Example 2, 4 parts by weight of a compatibilizer, and 66 parts by weight of HDPE were dry-blended in a double cone mixer (MYDCM-100, MYEONG WOO MICRON SYSTEM) for 30 minutes to prepare a dry blend in a pellet form to be used as a nanocomposite blend layer (A).

Layer (C): AB130 pellet (LG CHEM) in which a PE main chain was grafted with maleic anhydride (MAH) to introduce a polar group was used.

Layer (D): EVOH (E105B; Kuraray) pellet was used.

Layer (E): Lupolene 4261 (HMWPE; Basell) pellet was used.

Layer (B): Burrs of a blow molded article comprising Layers (A), (C), (D) and (E) were pulverized and extruded to prepare a pellet for Layer (B).

The obtained pellets were extruded in order of (A)/(B)/(C)/(D)/(C)/(A) using a co-extrusion die (die temperature: 230° C.) to prepare a parison in a molten state. The parison was disposed in a mold and was blown with pressurized air with a pressure of 5 kg/cm². The resulting molded article was cooled, and then was removed from the mold. As a result, a bottle with layer thicknesses of 0.5/0.3/0.2/0.2/0.2/0.5 mm, a diameter of 80 mm, a height of 200 mm and a volume of 500 mL was obtained. The bottle was charged with 500 g of Ref.C (a mixture of 50% toluene and 50% isooctane) and was let alone in a thermostatic chamber at 60° C. for 60 days. After 30 days, a change in weight of the content was measured and the results are shown in Table 1. The content was removed from the bottle immediately after the measurement. After 5 minutes, a specimen with a width of 15 mm was cut from a side of the bottle and the adhesive strength between Layers (B) and (C) was measured in a thermostatic chamber at 80° C. using T-peeling method at a peeling rate of 50 mm/min. The results are shown in Table 2.

### Example 3

Layer (A): 30 parts by weight of the nylon 6/intercalated clay nanocomposite prepared in the Preparation Example 2, 4 parts by weight of a compatibilizer, and 66 parts by weight of HDPE were dry-blended in a double cone mixer (MYDCM-100, MYEONG WOO MICRON SYSTEM) for 30 minutes to prepare a dry blend in a pellet form to be used as a nanocomposite blend layer (A).

Layer (C): AB130 pellet (LG CHEM) in which a PE main chain was grafted with maleic anhydride (MAH) to introduce a polar group was used.

Layer (D): EVOH (E105B; Kuraray) pellet was used.

Layer (E): Lupolene 4261 (HMWPE; Basell) pellet was used.

Layer (B): Burrs of a blow molded article comprising Layers (A), (C), (D) and (E) were pulverized and extruded to prepare a pellet for Layer (B).

The obtained pellets were extruded in order of (E)/(B)/(A)/(E)/(A)/(E) using a co-extrusion die (die temperature: 230° C.) to prepare a parison in a molten state. The parison was disposed in a mold and was blown with pressurized air with a pressure of 5 kg/cm². The resulting molded article was cooled, and then was removed from the mold. As a result, a bottle with layer thicknesses of 0.5/0.3/0.2/0.2/0.2/0.5 mm, a diameter of 80 mm, a height of 200 mm and a volume of 500 mL was obtained. The bottle was charged with 500 g of Ref.C (a mixture of 50% toluene and 50% isooctane) and was let alone in a thermostatic chamber at 60° C. for 60 days. After 30 days, a change in weight of the content was measured and the results are shown in Table 1. The content was removed from the bottle immediately after the measurement. After 5 minutes, a specimen with a width of 15 mm was cut from a side of the bottle and the adhesive strength between Layers (B) and (A) was measured in a thermostatic chamber at 80° C. using T-peeling method at a peeling rate of 50 mm/min. The results are shown in Table 2.

### Example 4

Layer (A): 4 parts by weight of the nylon 6/intercalated clay nanocomposite prepared in the Preparation Example 2, 2 parts by weight of a compatibilizer, and 94 parts by weight of HDPE were dry-blended in a double cone mixer (MYDCM-100, MYEONG WOO MICRON SYSTEM) for 30 minutes to prepare a dry blend in a pellet form to be used as a nanocomposite blend layer (A).

Layer (C): AB130 pellet (LG CHEM) in which a PE main chain was grafted with maleic anhydride (MAH) to introduce a polar group was used.

Layer (D): EVOH (E105B; Kuraray) pellet was used.

Layer (E): Lupolene 4261 (HMWPE; Basell) pellet was used.

Layer (B): Burrs of a blow molded article comprising Layers (A), (C), (D) and (E) were pulverized and extruded to prepare a pellet for Layer (B).

The obtained pellets were extruded in order of (E)/(B)/(A)/(E)/(A)/(E) using a co-extrusion die (die temperature: 230° C.) to prepare a parison in a molten state. The parison was disposed in a mold and was blown with pressurized air with a pressure of 5 kg/cm². The resulting molded article was cooled, and then was removed from the mold. As a result, a bottle with layer thicknesses of 0.5/0.3/0.2/0.2/0.2/0.5 mm, a diameter of 80 mm, a height of 200 mm and a volume of 500 mL was obtained. The bottle was charged with 500 g of Ref.C (a mixture of 50% toluene and 50% isooctane) and was let alone in a thermostatic chamber at 60° C. for 60 days. After 30 days, a change in weight of the content was measured and the results are shown in Table 1. The content was removed from the bottle immediately after the measurement. After 5 minutes, a specimen with a width of 15 mm was cut from a side of the bottle and the adhesive strength between Layers (B) and (A) was measured in a thermostatic chamber at 80° C. using T-peeling method at a peeling rate of 50 mm/min. The results are shown in Table 2.

### Example 5

Layer (A): 45 parts by weight of the nylon 6/intercalated clay nanocomposite prepared in the Preparation Example 2, 15 parts by weight of a compatibilizer, and 40 parts by weight of HDPE were dry-blended in a double cone mixer (MYDCM-100, MYEONG WOO MICRON SYSTEM) for 30 minutes to prepare a dry blend in a pellet form to be used as a nanocomposite blend layer (A).

Layer (C): AB130 pellet (LG CHEM) in which a PE main chain was grafted with maleic anhydride (MAH) to introduce a polar group was used.

Layer (D): EVOH (E105B; Kuraray) pellet was used.

Layer (E): Lupolene 4261 (HMWPE; Basell) pellet was used.

Layer (B): Burrs of a blow molded article comprising Layers (A), (C), (D) and (E) were pulverized and extruded to prepare a pellet for Layer (B).

The obtained pellets were extruded in order of (E)/(B)/(A)/(E)/(A)/(E) using a co-extrusion die (die temperature: 230° C.) to prepare a parison in a molten state. The parison was disposed in a mold and was blown with pressurized air with a pressure of 5 kg/cm². The resulting molded article was cooled, and then was removed from the mold. As a result, a bottle with layer thicknesses of 0.5/0.3/0.2/0.2/0.2/0.5 mm, a diameter of 80 mm, a height of 200 mm and a volume of 500 mL was obtained. The bottle was charged with 500 g of Ref.C (a mixture of 50% toluene and 50% isooctane) and was let alone in a thermostatic chamber at 60° C. for 60 days. After 30 days, a change in weight of the content was measured and the results are shown in Table 1. The content was removed from the bottle immediately after the measurement. After 5 minutes, a specimen with a width of 15 mm was cut from a side of the bottle and the adhesive strength between Layers (B) and (A) was measured in a thermostatic chamber at 80° C. using T-peeling method at a peeling rate of 50 mm/min. The results are shown in Table 2.

### Example 6

Layer (A): 45 parts by weight of the nylon 6/intercalated clay nanocomposite prepared in the Preparation Example 2, 15 parts by weight of a compatibilizer, and 40 parts by weight of HDPE were dry-blended using belt-type feeders K-TRON Nos. 1, 2 and 3, respectively, and put in a main hopper of an extruder to prepare a pellet for a nanocomposite blend layer (A).

Layer (C): AB130 pellet (LG CHEM) in which a PE main chain was grafted with maleic anhydride (MAH) to introduce a polar group was used.

Layer (D): EVOH (E105B; Kuraray) pellet was used.

Layer (E): Lupolene 4261 (HMWPE; Basell) pellet was used.

Layer (B): Burrs of a blow molded article comprising Layers (A), (C), (D) and (E) were pulverized and extruded to prepare a pellet for Layer (B).

The obtained pellets were extruded in order of (E)/(B)/(A)/(E)/(A)/(E) using a co-extrusion die (die temperature: 230° C.) to prepare a parison in a molten state. The parison was disposed in a mold and was blown with pressurized air with a pressure of 5 kg/cm². The resulting molded article was cooled, and then was removed from the mold. As a result, a bottle with layer thicknesses of 0.5/0.3/0.2/0.2/0.2/0.5 mm, a diameter of 80 mm, a height of 200 mm and a volume of 500 mL was obtained. The bottle was charged with 500 g of Ref.C (a mixture of 50% toluene and 50% isooctane) and was let alone in a thermostatic chamber at 60° C. for 60 days. After 30 days, a change in weight of the content was measured and the results are shown in Table 1. The content was removed from the bottle immediately after the measurement. After 5 minutes, a specimen with a width of 15 mm was cut from a side of the bottle and the adhesive strength between Layers (B) and (A) was measured in a thermostatic chamber at 80° C. using T-peeling method at a peeling rate of 50 mm/min. The results are shown in Table 2.

### Comparative Example 1

Layer (C): AB130 pellet (LG CHEM) in which a PE main chain was grafted with maleic anhydride (MAH) to introduce a polar group was used.

Layer (D): EVOH (E105B; Kuraray) pellet was used.

Layer (E): Lupolene 4261 (HMWPE; Basell) pellet was used.

Layer (B): Burrs of a blow molded article comprising Layers (C), (D) and (E) were pulverized and extruded to prepare a pellet for Layer (B).

The obtained pellets were extruded in order of (E)/(B)/(C)/(D)/(C)/(E) using a co-extrusion die (die temperature: 230° C.) to prepare a parison in a molten state. The parison was disposed in a mold and was blown with pressurized air with a pressure of 5 kg/cm². The resulting molded article was cooled, and then was removed from the mold. As a result, a bottle with layer thicknesses of 0.5/0.310.2/0.2/0.2/0.5 mm, a diameter of 80 mm, a height of 200 mm and a volume of 500 mL was obtained. The bottle was charged with 500 g of Ref.C (a mixture of 50% toluene and 50% isooctane) and was let alone in a thermostatic chamber at 60° C. for 60 days. After 30 days, a change in weight of the content was measured and the results are shown in Table 1. The content was removed from the bottle immediately after the measurement. After 5 minutes, a specimen with a width of 15 mm was cut from a side of the bottle and the adhesive strength between Layers (B) and (C) was measured in a thermostatic chamber at 80° C. using T-peeling method at a peeling rate of 50 mm/min. The results are shown in Table 2.

### Comparative Example 2

Layer (C): AB130 pellet (LG CHEM) in which a PE main chain was grafted with maleic anhydride (MAH) to introduce a polar group was used.

Layer (D): Nylon 6 (EN300; KP Chemical) pellet was used.

Layer (E): Lupolene 4261 (HMWPE; Basell) pellet was used.

Layer (B): Burrs of a blow molded article comprising Layers (C), (D) and (E) were pulverized and extruded to prepare a pellet for Layer (B).

The obtained pellets were extruded in order of (E)/(B)/(C)/(D)/(C)/(E) using a co-extrusion die (die temperature: 230° C.) to prepare a parison in a molten state. The parison was disposed in a mold and was blown with pressurized air with a pressure of 5 kg/cm². The resulting molded article was cooled, and then was removed from the mold. As a result, a bottle with layer thicknesses of 0.5/0.3/0.2/0.2/0.2/0.5 mm, a diameter of 80 mm, a height of 200 mm and a volume of 500 mL was obtained. The bottle was charged with 500 g of Ref.C (a mixture of 50% toluene and 50% isooctane) and was let alone in a thermostatic chamber at 60° C. for 60 days. After 30 days, a change in weight of the content was measured and the results are shown in Table 1. The content was removed from the bottle immediately after the measurement. After 5 minutes, a specimen with a width of 15 mm was cut from a side of the bottle and the adhesive strength between layers (B) and (C) was measured in a thermostatic chamber at 80° C. using T-peeling method at a peeling rate of 50 mm/min. The results are shown in Table 2.

### Experimental Example

a) Barrier property

The 500 mL bottles manufactured in Examples 1-6 and Comparative Examples 1 and 2 were respectively charged with 500 g of Ref.C (a mixture of 50% toluene and 50% isooctane) and were let alone in a thermostatic oven at 60° C. for 60 days. The weight change was determined.

b) Peel strength

The content was removed from the bottle immediately after the determination of the weight change. After 5 minutes, a specimen with a width of 15 mm was cut from a side of the bottle and the adhesive strength between Layers (B) and (C) was measured in a thermostatic chamber at 80° C. using T-peeling method at a peeling rate of 50 mm/min.

TABLE 1
Reduction in weight of containers

| | | | | | | | Comparative | Comparative |
|---|---|---|---|---|---|---|---|---|
| | Example 1 | Example 2 | Example 3 | Example 4 | Example 5 | Example 6 | Example 1 | Example 2 |
| Reduction | 0.9 g | 0.5 g | 1.1 g | 1.2 g | 0.3 g | 0.4 g | 1.2 g | 11.5 g |
| in weight | | | | | | | | |

TABLE 2
Peel strength of containers

| | | | | | | | Comparative | Comparative |
|---|---|---|---|---|---|---|---|---|
| | Example 1 | Example 2 | Example 3 | Example 4 | Example 5 | Example 6 | Example 1 | Example 2 |
| Peel | 6200 | 7500 | 8100 | 8600 | 7100 | 7000 | 1800 | 2400 |
| strength | | | | | | | | |

As shown in Tables 1 and 2, containers of Examples 1 to 6 have a better barrier property and a higher peel strength than those of Comparative Examples 1 and 2.

The multi-layer plastic container according to an embodiment of the present invention has a good barrier property, can maintain a sufficient adhesive strength even when contacting gasoline or gasohol, has good durability over a long period of time, and has a high adhesive strength at high temperature, and thus can be effectively used as a fuel tank for vehicles.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A multi-layer container having a barrier property comprising:
a nanocomposite blend layer; and
at least one selected layer from the group consisting of a polyolefin layer, a layer of a resin having a barrier property and a regrind layer,
in which the nanocomposite blend layer is prepared from a dry-blended composition comprising:
40 to 98 parts by weight of a polyolefin resin;
0.5 to 60 parts by weight of a nanocomposite having a barrier property, selected from the group consisting of an ethylene-vinyl alcohol copolymer/intercalated clay nanocomposite, a polyamide/intercalated clay nanocomposite, an ionomer/intercalated clay nanocomposite, and a polyvinyl alcohol/intercalated clay nanocomposite; and
1 to 30 parts by weight of a compatibilizer.

2. The multi-layer container of claim 1, wherein the polyolefin resin used in the nanocomposite blend layer is at least one compound selected from the group consisting of a high density polyethylene (HDPE), a low density polyethylene (LDPE), a linear low density polyethylene (LLDPE), an ethylene-propylene copolymer, metallocene polyethylene, and polypropylene.

3. The multi-layer container of claim 1, wherein the intercalated clay is at least one compound selected from the group consisting of montmorillonite, bentonite, kaolinite, mica, hectorite, fluorohectorite, saponite, beidelite, nontronite, stevensite, vermiculite, hallosite, volkonskoite, suconite, magadite, and kenyalite.

4. The multi-layer container of claim 1, wherein the intercalated clay comprises 1 to 45 wt % of an organic material.

5. The multi-layer container of claim 4, wherein the organic material has at least one functional group selected from the group consisting of primary ammonium to quaternary ammonium, phosphonium, maleate, succinate, acrylate, benzylic hydrogen, dimethyldistearylammonium, and oxazoline.

6. The multi-layer container of claim 1, wherein the ethylene-vinyl alcohol copolymer contains 10 to 50 mol % of ethylene.

7. The multi-layer container of claim 1, wherein the polyamide is nylon 4.6, nylon 6, nylon 6.6, nylon 6.10, nylon 7, nylon 8, nylon 9, nylon 11, nylon 12, nylon 46, MXD6, amorphous polyamide, a copolymerized polyamide containing at least two of these, or a mixture of at least two of these.

8. The multi-layer container of claim 1, wherein the ionomer has a melt index of 0.1 to 10 g/10 min (190° C., 2,160 g).

9. The multi-layer container of claim 1, wherein the compatibilizer is one or more compounds selected from the group consisting of an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, and a maleic anhydride modified (graft) ethylene-vinyl acetate copolymer.

10. The multi-layer container of claim 1, manufactured using blow molding, extrusion molding, pressure molding or injection molding.

11. The multi-layer container of claim 1, wherein the nanocomposite blend layer is prepared from a dry-blended composition comprising: 70 to 96 parts by weight of a polyolefin resin; 3 to 30 parts by weight of a nanocomposite having a barrier property, selected from the group consisting of an ethylene-vinyl alcohol copolymer/intercalated clay nanocomposite, a polyamide/intercalated clay nanocomposite, an ionomer/intercalated clay nanocomposite, and a polyvinyl alcohol/intercalated clay nanocomposite; and 2 to 15 parts by weight of a compatibilizer.

12. The multi-layer container of claim 1, wherein the layer of a resin having a barrier property is composed of at least one material selected from the group consisting of an ethylene-vinyl alcohol copolymer, a polyamide, an ionomer, and a polyvinyl alcohol.

13. The multi-layer container of claim 1, having a layered structure selected from the group consisting of polyolefin layer/nanocomposite blend layer, polyolefin layer/nanocomposite blend layer/polyolefin layer, nanocomposite blend layer/polyolefin layer/nanocomposite blend layer, polyolefin layer/nanocomposite blend layer/regrind layer, nanocomposite blend layer/resin layer having a barrier property/nanocomposite blend layer, nanocomposite blend layer/polyolefin layer/nanocomposite blend layer/polyolefin layer, nanocomposite blend layer/regrind layer/polyolefin layer/nanocomposite blend layer, polyolefin layer/nanocomposite blend layer/polyolefin layer/nanocomposite blend layer/polyolefin layer, regrind layer/nanocomposite blend layer/polyolefin layer/nanocomposite blend layer/polyolefin layer, nanocomposite blend layer/regrind layer/nanocomposite blend layer/polyolefin layer/nanocomposite blend layer, nanocomposite blend layer/regrind layer/nanocomposite blend layer/polyolefin layer/nanocomposite blend layer/polyolefin layer, nanocomposite blend layer/polyolefin layer/nanocomposite blend layer/polyolefin layer/nanocomposite blend layer/polyolefin layer, polyolefin layer/regrind layer/nanocomposite blend layer/polyolefin layer/nanocomposite blend layer/polyolefin layer, and polyolefin layer/nanocomposite blend layer/regrind layer/nanocomposite blend layer/polyolefin layer/nanocomposite blend layer.

14. The multi-layer container of claim 1, further comprising an adhesive layer.

15. The multi-layer container of claim 14, wherein the adhesive layer is composed of one or more compounds selected from the group consisting of an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, and a maleic anhydride modified (graft) ethylene-vinyl acetate copolymer.

16. The multi-layer container of claim 14, having a layered structure selected from the group consisting of regrind layer/polyolefin layer/adhesive layer/nanocomposite blend layer, resin layer having a barrier property/adhesive layer/regrind layer/nanocomposite blend layer, resin layer having a barrier property/adhesive layer/nanocomposite blend layer/polyolefin layer, resin layer having a barrier property/adhesive layer/nanocomposite blend layer/regrind layer, nanocomposite blend layer/adhesive layer/resin layer having a barrier property/adhesive layer/nanocomposite blend layer, nanocomposite blend layer/adhesive layer/resin layer having a barrier property/adhesive layer/polyolefin layer, polyolefin layer/adhesive layer/resin layer having a barrier property/adhesive layer/nanocomposite blend layer, nanocomposite blend layer/regrind layer/adhesive layer/resin layer having a barrier property/adhesive layer/nanocomposite blend layer, nanocomposite blend layer/polyolefin layer/adhesive layer/resin layer having a barrier property/adhesive layer/polyolefin layer, polyolefin layer/regrind layer/adhesive layer/nanocomposite blend layer/adhesive layer/polyolefin layer, and polyolefin layer/nanocomposite blend layer/adhesive layer/resin layer having a barrier property/adhesive layer/polyolefin layer.

17. The multi-layer container of claim 1, wherein the weight ratio of the resin having a barrier property to the intercalated clay in the nanocomposite is 58.0:42.0 to 99.9:0.1.

18. A fuel tank for vehicles using the multi-layer container of claims 1.
